(19) United States
(12) Patent Application Publication
(10) Pub. No.: US 2013/0151659 A1
(43) Pub. Date: Jun. 13, 2013

(54) METHOD TO USE LOCATION TO PRESENT DESIRABLE AND CONDITIONAL MEDIA CONTENT

(71) Applicants: William P. Alberth, Prairie Grove, IL (US); William S. Hede, Lake in the Hills, IL (US)

(72) Inventors: William P. Alberth, Prairie Grove, IL (US); William S. Hede, Lake in the Hills, IL (US)

(73) Assignee: MOTOROLA MOBILITY, INC., Libertyville, IL (US)

(21) Appl. No.: 13/323,943

(22) Filed: Dec. 13, 2011

(51) Int. Cl. G06F 15/16

(52) U.S. Cl. 709/217

(57) ABSTRACT

A method to present desirable consumable media content for a mobile communication device during the occurrence of a likely future out of data network coverage condition. A future period of non-availability is determined, for a first data network that is associated with the mobile communication device, by analyzing likely occurrence of an out of data network coverage condition. Prior to the occurrence of the out of data network coverage condition: the method will calculate the amount and type of downloadable consumable media content that the mobile communication device will present for use during occurrence of the out of data network coverage condition. The method downloads the consumable media content for consumption or presentation via the mobile communication device.

### FIELD OF THE DISCLOSURE

The present disclosure relates generally to downloadable media content and more particularly to conditional downloadable media content, wherein the location of the media content player and its connectivity to an available communication network is at least one condition affecting the media content to be downloaded.

### BACKGROUND

Users of mobile communication devices {hereinafter referred to as “user(s)”} such as smartphones, tablet computers, media content players, and gaming devices, for example, have at their disposal ever increasing amounts of media content to download to their devices. Users have become accustomed to managing the amount of data and even scheduling of data download. However, users do not control the access to servers in every location that their mobile communication device may encounter. For example, there may be some locations during a business or vacation trip in which access to Wi-Fi location is either limited, costly, or non-existent. Notably, even within a large technologically sophisticated country like the United States of America, only seventy-six percent of airports offer free Wi-Fi. Locations outside of metropolitan areas, such as beach resorts, may not have either Wi-Fi or cellular coverage.

In addition, data handling by users can get complicated. For example, a user may decide to store his music and video files on his mobile communication device before traveling. However, such storage often requires synching the mobile communication device with an online database or a local personal computer or storage device. It should also be noted that the amount of storage required for high definition video and high quality audio files is increasing exponentially.

Recent trends include storing the large amounts of data in several offsite servers (i.e., “cloud-based computing”), and restricting or limiting a mobile communication device user's data usage. Should a user exceed a predetermined threshold, the user can be expected to pay an additional fee for the excess data usage. Furthermore, memory or storage capability may be cut because of increased cost, thus affecting applications that use the mobile communication device's onboard memory.

However, certain disadvantages can accompany cloud-based computing, including network overload and poor performance. Another disadvantage can be poor geographical coverage where the most up to date cellular or bandwidth coverage is absent. Currently, 4G technology such as long term evolution wireless (LTE) is replacing 3G technology; yet 4G is not ubiquitous and the need for high-speed data services remains great. Users now expect rapid data transmission and reception.

One final disadvantage may be simply that physical space associated with any one server per user may be limited in order to meet the demands of everyone with a mobile communication device (now estimate to be in the hundreds of millions at a minimum). Likely, the use of extra data space will cost the user additional fees.

Accordingly, there is a need for a method to use location to present desirable and conditional media content.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system diagram in accordance with one or more described embodiments.

FIG. 2 is a flowchart of an exemplary method of estimating a user's time out of primary network coverage.

FIG. 3 is a flowchart of an exemplary method for presenting desirable media content to the user as conditioned by the user's time out of primary network coverage.

FIG. 4 is an exemplary user interface for a mobile communication device in accordance with one or more exemplary embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Described herein is a method to present desirable consumable media content for a mobile communication device during the occurrence of a likely future out of data network coverage condition. An itinerary that corresponds to the mobile communication device and its user is determined for example by analyzing calendar or email content. Thereafter, a future period of availability is determined, for a primary data network that is associated with the mobile communication device, by analyzing likely occurrence of an out of data network coverage condition based on the itinerary corresponding to the mobile communication device. Prior to the occurrence of the out of data network coverage condition: the method will calculate the amount and type of downloadable consumable media content that the mobile communication device will present for use during occurrence of the out of data network coverage condition. In addition, the method downloads the consumable media content for consumption (by the user of the mobile communication device) or presentation via the mobile communication device. The amount of media content downloaded is related to the determined future period of out of data network coverage of the primary data network associated with the mobile communication device.

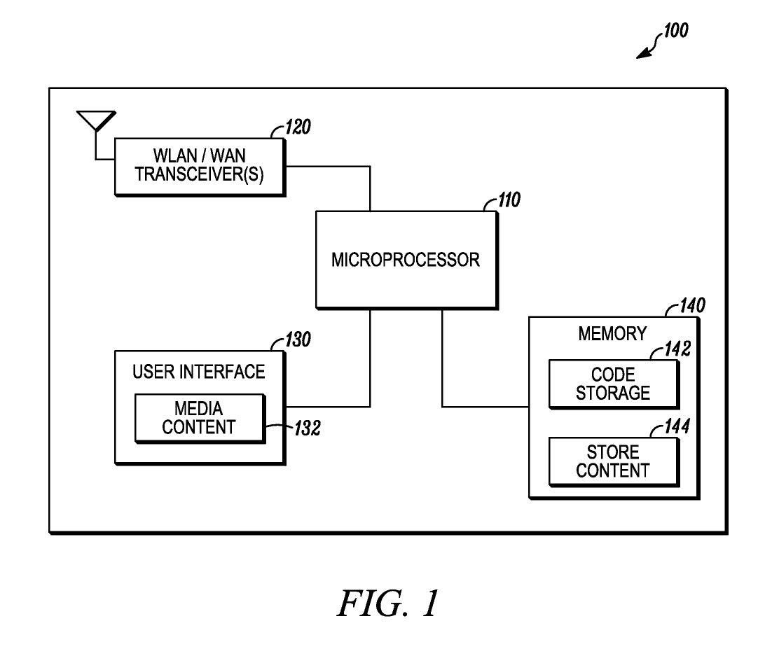

FIG. 1 is an exemplary system diagram that is illustrated to explain one or more embodiments. System 100 can be employed within a communication device and includes a microprocessor 110 that may reside on one or more processing chip substrates. Microprocessor 110 can be communicatively and electrically coupled to several other structures or entities within system 100, including one or more transceivers 120, at least one user interface 130, and memory 140. Tranceiver(s) 120 can be useful in a wide area network (WAN) or a wide local area network (WLAN). The transceivers may also include Global Positioning System (GPS) and other equivalent satellite navigational systems, for example, the Russian Global Navigation Satellite System (GLONASS), the European Union Galileo Positioning System, the Chinese Compass Navigation System, and the Indian Regional Navigational Satellite System), and may also include Near Field Communications (NFC), and Bluetooth™.

User interface 130 shown in FIG. 1 interacts with media content 132 that can be presented or controlled by user interface 130 for use by a user of a communication device. Memory 140 can include code storage cells 142 or space for algorithms, code, or software. Memory 140 can also include a store content cell 144 that is useful for storing or recording content that may have been downloaded/received or available for upload/transmission by system 100.

The communication device (not shown) in which system 100 can be employed inside of or communicatively connected to can be a smartphone, a set-top box (i.e., cable/satellite capable), a personal digital assistant, a music player, tablet computing device, gaming device, mobile phone, portable computer, and various other similar electronic communication devices that are either wired or wireless.

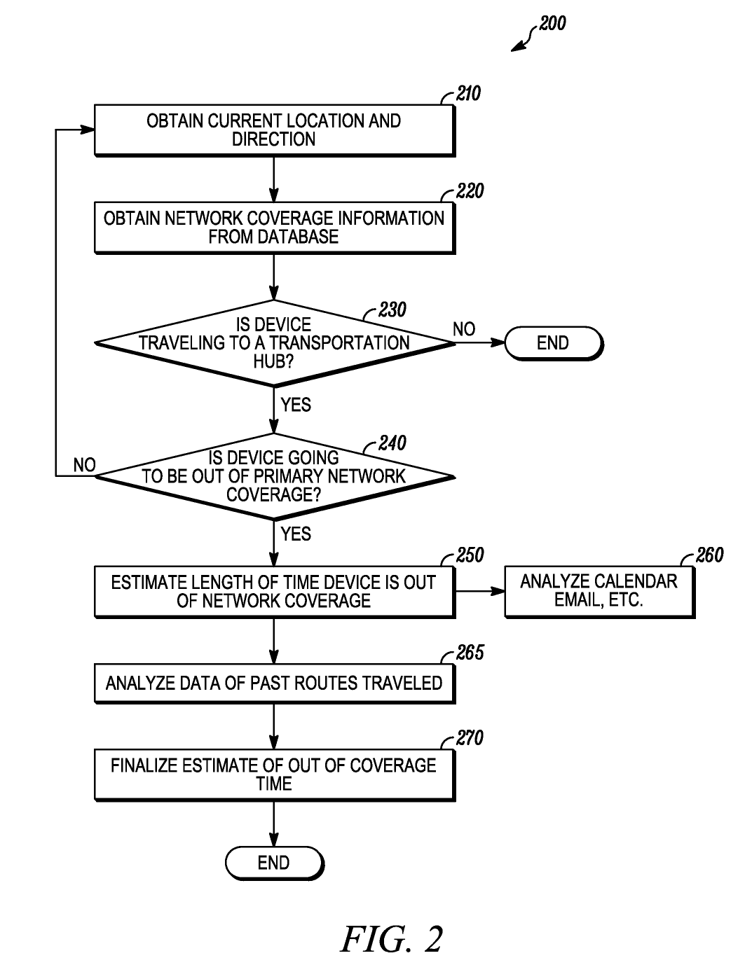

FIG. 2 is a flowchart 200 of an exemplary method for estimating a user's time out of primary network coverage based on information derived from or associated with the communication device. Operation 210 obtains current location and direction of the communication device and thus of the user of the communication device. Current location and direction can be obtained via sensor technology, such as accelerometers, Bluetooth sensor, near field communication sensors, Wi-Fi, WLAN, WAN, or global positioning system (GPS) satellite transceiver. Operation 220 obtains network coverage information from one or more databases that may have cellular or GPS or Wi-Fi network availability data. Decision operation 230 inquires whether the communication device (aka user) is travelling toward a transportation hub such as an airport, train station, bus station, or turnpike, for example. If there is no data or user input indicating travel to a transportation hub, then the method for estimating a user's time out of primary network coverage ends. Alternatively, a second decision operation, operation 240 inquires whether the device is going to be out of primary network coverage. Out of primary network coverage maybe predicted from the direction of travel and a map of network coverage provided to the device. Affirmative evidence that the device will soon be outside of primary network coverage (i.e., the method has determined that a future period of non-availability is likely for at least a first data network associated with the mobile communication device) leads to operation 250 for preliminarily estimating length of time the device is out of network coverage. In the event that the device is determined to not soon to be out of primary network coverage during step 240, then the method continues to track location and direction of the device via operation 210. The time frame for future or impending out of coverage status can be predetermined and can range from several seconds to several days, for example.

Operation 250 preliminarily estimates length of time the device is out of network coverage by first analyzing calendar, email, social network information in operation 260. Clearly, additional sources of information can be assessed as well, including recent purchase information (e.g., tickets, clothes for a non-local climate, luggage, books, music, pet shelter-care), for example. Likewise, operation 265 can provide out of network coverage information by analyzing data of past routes traveled and the associated time for traveling the past routes, and previous history of time out of network. Notably, operations 260, 265 can be combined or performed separately depending on the efficacy of the derived information.

Upon completion of operations 260, 265, operation 270 finalizes the estimated length of time the device is out of primary network coverage. The final estimation can be used in another method or process to determine amount of downloadable media content the communication device will need or require while operating outside of the primary network coverage area.

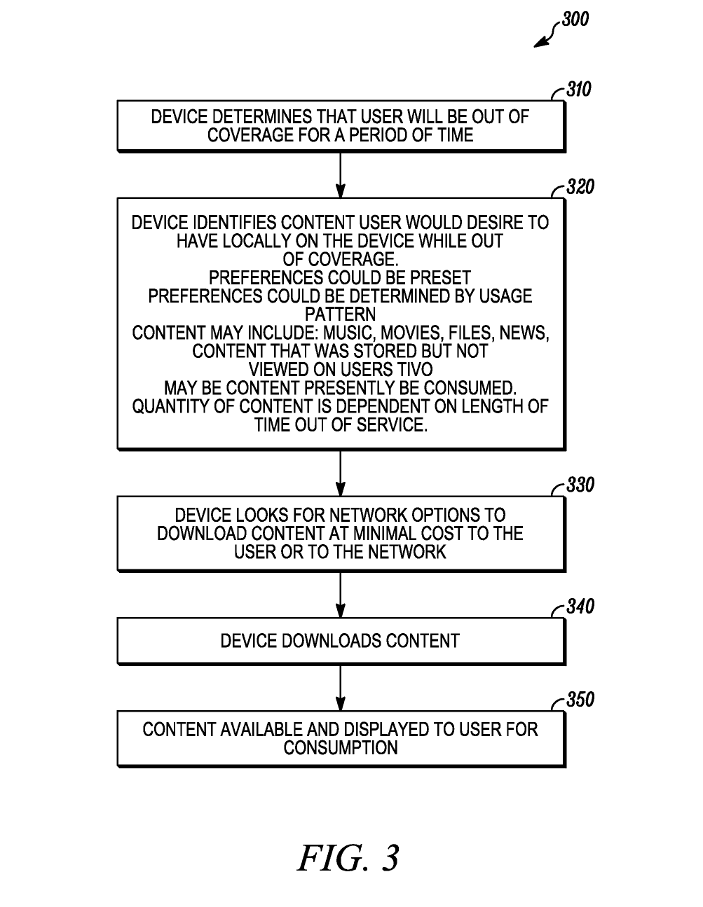

FIG. 3 is a flowchart 300 illustrating an exemplary method for presenting desirable media content to the user as conditioned by the user's time out of primary network coverage. Upon finalization or completion of an estimated future or impending period reflecting how long the communication device is likely to be out of primary network coverage, operation 310 provides a threshold period or span of time for the device to conditionally operate in. One type of conditional operation is shown in operation 320. Operation 320 identifies media content that a user is likely to desire and/or enjoy and, therefore, would prefer to have the media content stored or presented locally on the communication device while the communication device is out of primary network coverage. User preferences can be inputted in advance or user preferences can be derived from former usage patterns. The media content can include music, movies, files, news, on-demand or recorded media content from a digital video recorder. Notably, the quantity or amount of media content to be downloaded to the communication device is dependent on length of time that the device has been estimate to be out of primary network service.

Operation 330 searches or analyzes other network options that will enable the download of the media content in operation 320. One criteria for selecting another or second network can be the cost to the user of the communication device. Another criteria can be the cost to the network itself in its capacity to handle the data traffic associated with the downloading of the media content. Operation 340 directs the communication device to receive or download the media content. The download rate can be controlled and the download can be structured to occur automatically.

Thereafter, operation 350 notifies the user of the communication device that the media content is available and presents the media content for the user's consumption. That is video related media content is displayed or presented on the communication device or presented via the communication device to an external display, such as a high-definition display or monitor. Likewise, audio related media content is played through speakers of the communication device or via the communication device to external speakers.

A user may choose to implement one or more preferences for the selection of media content. In one embodiment, the user selects downloadable media content based on size of the data packet. For example, a cross-country airplane trip can require a different sized data packet than a cross-country train ride. For example, one data packet may have more individual songs than another data packet. In a second embodiment, the user can prioritize the downloadable media content to be presented according to whether the media content was recently purchased versus a regular selection by the user. In addition, a user may select subscription-based media content over media content already owned because the subscription-based media content may be more current.

In another embodiment, a user may choose to pre-load certain websites as downloadable media content because he usually surfs the web-sites as part of his daily routine. In contrast, another embodiment offers a user a “concierge” service in that the communication device is provided with suggested downloadable media content that may reflect the user's interest in politics, entertainment, history, geography, and sports, for example. This “concierge” service can be coupled with travel to one or more destinations by the user so that the user has at his disposal advance knowledge, trivia, and tidbits of the local region and its cultural interests.

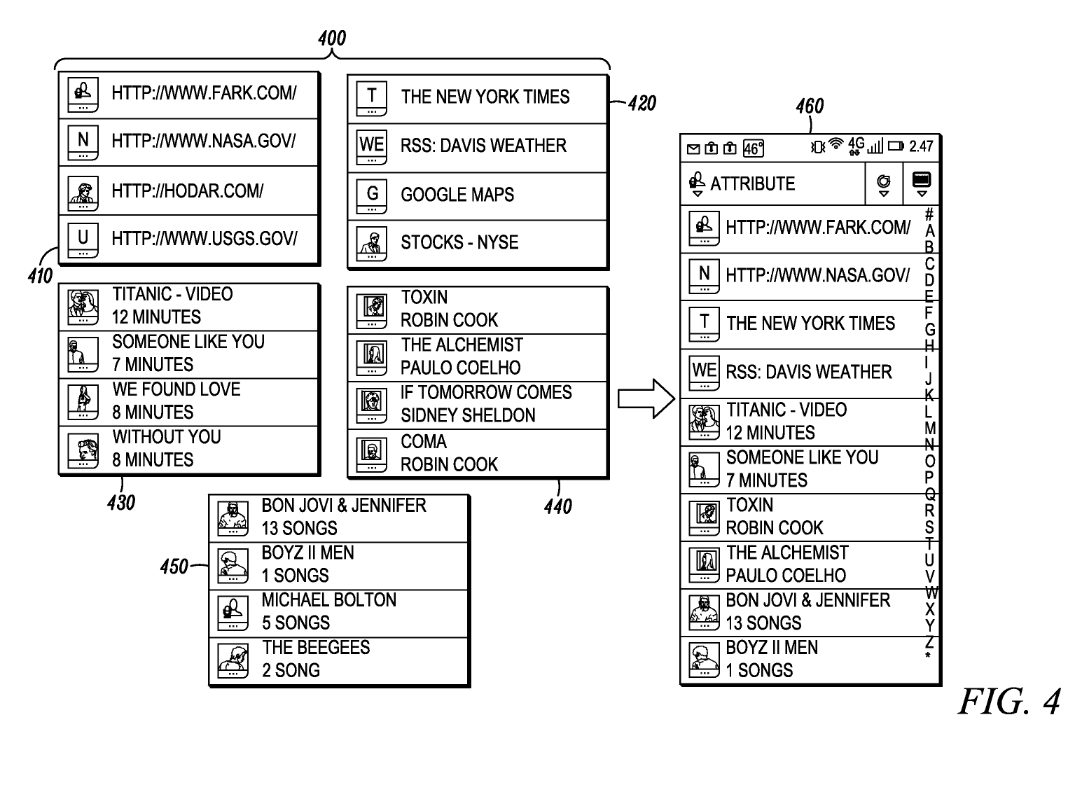

FIG. 4 is an exemplary user interface 460 for a mobile communication device in accordance with one or more exemplary embodiments. Specifically, one or more downloadable media content categories 400 can include websites 410, applications 420, movies 430, books 440, and music selections 450, for example. In addition, subscription services can be included as well. The categories allow the communication device to download selected media content based on user preference and the estimated period of out of primary network coverage that the communication device will operate in. Accordingly, the method or process, exemplarily shown in FIGS. 2 and 3 along with input from the user, yields a user interface 460 that reflects desired downloadable media content for the user's consumption during an extended period of out of primary network coverage. Therefore, the downloadable media content was transmitted over a secondary network such as a home Wi-Fi network versus a 4G cellular network (i.e., considered the primary network for a mobile communication device), for example.

The selections shown in user interface 460 can be stored in memory permanently or temporally. If stored temporally, the media content can be “flushed” once the communication device has returned to the primary network data coverage. The flushing of the memory can also occur once a predefined time period has passed as well. The flushing of the memory can also occur once the downloadable media content has been consumed once or a predetermined # of times.

Wireless networks operate by transmitting signals from a base to the wireless device using a predetermined protocol. If the device is close enough to the base to transfer data, the device is within the data network coverage. If the device is too far from a base to transfer signals, the device is out of network coverage.

Data such as websites and content that can be transferred to the device is downloadable. When the device is receiving data, the process is commonly referred to “downloading”.

Data may be stored on or within the device's memory location. Eventually the data maybe old and no longer useful for consumption by the device's user or presentable for the device, or the data may have been consumed and maybe no longer desired. In this event, the data takes up valuable space in the memory and should preferably be flushed or deleted from the memory. The cells in the memory may be marked as free and new information may overwrite data no longer needed. The cells may also be overwritten immediately with fixed or random patterns of bits.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.
Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions, and the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer executed, computerized, software implemented, or computer implemented. In addition these operations are often handled as non-transitory instructions.

In practice, one or more processor devices can carry out the described operations, instructions, tasks, and functions; and the various block components shown in the figures herein may be realized by any number of hardware, software, and/or firmware components configured to perform the specified functions. For example, an embodiment of a system or a component may employ various integrated circuit components, including memory storage elements, digital signal processing elements, logic elements, look up tables, or the like, which may carry out a variety of functions under the control of one or more microprocessors or other equivalent control devices.

For the sake of brevity, conventional techniques related to signal processing, data transmission, signaling, network control, computer architecture, and other functional aspects of the systems (and one or more individual operating components of the systems) may not be described in detail herein. Furthermore, the connecting lines shown in the various figures contained herein are intended to represent exemplary functional relationships as well as possible physical couplings between the various elements. It should be noted that many alternative or additional functional relationships or physical connections may be present in an embodiment of the subject matter.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Likewise, computer-readable storage medium can comprise a non-transitory machine readable storage device, having stored thereon a computer program that include a plurality of code sections for performing operations, steps, or a set of instructions.

Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

We claim:

1. A method to present desirable consumable media content for a mobile communication device during occurrence of a future out of data network coverage condition, comprising the steps of:
determining a future period of non-availability for at least a first data network associated with the mobile communication device by analyzing likely occurrence of an out of data network coverage condition;
prior to occurrence of the out of data network coverage condition:
calculating amount and type of downloadable consumable media content that the mobile communication device will present for use during occurrence of the out of data network coverage condition; and
downloading the consumable media content for consumption via the mobile communication device where the amount of content is related to the determined future period of out of data network coverage of the first data network associated with the mobile communication device.

2. The method according to claim 1, further comprising the step of:
determining sources of the downloadable consumable media content.

3. The method according to claim 1, further comprising the step of:
determining availability of a second data network.

4. The method according to claim 3, further comprising the step of:
selecting either the second data network or the first data network based on the amount of downloadable consumable media content that will be presented during the occurrence of the out of data network data coverage.

5. The method according to claim 1, further comprising the step of flushing at least a part of the consumable media content once the primary data network coverage is reestablished with the mobile communication device.

6. The method according to claim 1, further comprising the step of determining a final period for downloading the consumable media content prior to the determined future period of primary out of data network coverage associated with the mobile communication device.

7. The method according to claim 1, wherein the sources of the downloadable consumable media content are selected from the group comprising past mobile communication device usage, past consumable media usage, and recently downloaded consumable media content.

8. The method according to claim 3, wherein the second data network coverage includes either a wide-area network (WAN) or a wide area local network (WLAN).

9. The method according to claim 1, wherein the step of downloading the consumable media content occurs en route to a travel embarkation station.

10. The method according to claim 9, wherein the travel embarkation station is selected from the group consisting of airports, train stations, bus stations, and boat docks.

11. The method according to claim 5, further comprising the steps of:
determining that the mobile communication device is physically located at a debarkation station and that primary data network connectivity had been re-established in advance of flushing at least a part of the consumable media content.

12. The method according to claim 9, wherein the mobile communication device performs analysis on at least one of email, calendar, and social networking websites in order to predict length of the out of data network coverage.

13. The method according to claim 12, wherein the mobile communication device searches for documentation or confirmation of a travel ticket to predict length of the out of data network coverage.

14. The method according to claim 7, wherein selection of available downloadable consumable media content is provided once the mobile communication device determines that the future period of primary out of data network coverage is greater than a predetermined threshold period.

15. The method according to claim 14, wherein the predetermined threshold period is greater than 5 minutes.

16. The method according to claim 3, where in the mobile communication device chooses the first or second data network to download consumable media content based on at least one of a first or second data network coverage availability, and cost of loading the downloadable consumable media content via the first or second data network.

17. The method according to claim 1, further comprising the step of presenting a concierge feature service on the mobile communication device corresponding to a travel location.

18. The method according to claim 17, wherein the concierge feature service includes local tidbits about the travel location selected from the group consisting of politics, entertainment, history, maps, and sports.

19. The method according to claim 1, wherein the future out of data coverage condition is predicted from location and direction of travel data determined by the device.

20. The method according to claim 19, wherein the mobile communication device compares the location and direction of travel data with a network coverage map for the first network.
